(19) United States
(12) Patent Application Publication
(10) Pub. No.: US 2025/0358479 A1
(43) Pub. Date: Nov. 20, 2025

(54) REAL-TIME IDENTIFICATION OF MEDIA TRENDS AT A CONTENT SHARING PLATFORM

(71) Applicant: Google LLC, Mountain View, CA (US)

(72) Inventors: Hui Miao, Palo Alto, CA (US); Battulga Bayarsaikhan, Mountain View, CA (US); Rui Xu, Palo Alto, CA (US); Mingyan Gao, Los Altos, CA (US); Ye Jin, Palo Alto, CA (US); Sourabh Prakash Bansod, Mountain View, CA (US)

(21) Appl. No.: 19/209,412

(22) Filed: May 15, 2025

Related U.S. Application Data
(60) Provisional application No. 63/648,617, filed on May 16, 2024.

(51) Int. Cl. H04N 21/466

(52) U.S. Cl. CPC H04N 21/4667

(57) ABSTRACT

Methods and systems for real-time identification of media trends at a content sharing platform are provided. Embeddings representing features of a media item identified during a current time window are generated. Based on these embeddings, the system determines whether the similarity between the features of the media item and those of one or more additional media items identified during the same time window meets predefined similarity criteria. If the similarity criteria are satisfied, the media item and the additional media items are determined to correspond to an emerging media trend on the platform. An indication of this emerging media trend is then provided to a user of the platform via a client device during the current time window.

### RELATED APPLICATIONS

This non-provisional application claims priority to U.S. Provisional Patent Application No. 63/648,617, filed May 16, 2024, entitled “Real-Time Media Trend Identification in Short-Form Video Platforms,” which is incorporated herein by reference in its entirety for all purposes.

### TECHNICAL FIELD

Aspects and implementations of the present disclosure relate to methods and systems for real-time identification of media trends at a content sharing platform.

### BACKGROUND

A platform (e.g., a content sharing platform, etc.) can enable users to share content with other users of the platform. For example, a user of the platform can provide a media item (e.g., a video item, etc.) to the platform to be accessible by other users of the platform. The platform can include the media item in a media item corpus. The platform selects media items for sharing with users based on user interest. In some instances, one or more media items can be associated with a media trend. Media items associated with a media trend share a common concept or format. This common concept or format inspires the media item to be widely shared between users across the platform. In other instances, a media item can be associated with one or more other media characteristics. Detecting a media trend, identifying media items that are associated with the media trend, and determining other media characteristics of a media item can be time consuming and/or resource intensive for the platform.

### SUMMARY

The summary below is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes generating one or more embeddings representing features of a media item of a platform identified during a current time window. The method further includes determining, based on the one or more embeddings, whether a degree of similarity between the features of the media item and features of one or more additional media items of the platform identified during the current time window satisfies one or more similarity criteria. The method further includes, responsive to determining that the degree of similarity satisfies the one or more similarity criteria, determining that the media item and the one or more additional media items correspond to an emerging media trend of the platform. The method further includes providing, during the current time window, an indication of the emerging media trend for presentation to a user of the platform via a client device.

In some implementations, determining that the media item and the one or more additional media items correspond to an emerging media trend of the platform includes obtaining engagement data associated with the media item and the one or more additional media items, the engagement data representing user engagement with respect to the media item and the one or more additional media items during at least one of the current time window or a prior time window. The method further includes determining that the obtained engagement data satisfies one or more engagement criteria.

In some implementations, the method further includes obtaining a set of additional embeddings representing the features of the one or more additional media items. The method further includes providing the one or more embeddings representing the features of the media item, the set of additional embeddings representing the features of the one or more additional media items, and the obtained engagement data as an input to an anomaly engine. The anomaly engine detects a fluctuation of user engagement with content of the platform. The method further includes obtaining one or more outputs of the anomaly engine, the one or more outputs indicating one or more aggregated engagement metrics each representing a trend of user engagement with respect content having features matching at least one of the features of the media item or the features of the one or more additional media items. Determining that the obtained engagement data satisfies the one or more engagement criteria includes determining that a value of the one or more aggregated engagement metrics exceeds a threshold value.

In some implementations, the method further includes determining that the media item or an additional media item of the one or more additional media items satisfies one or more template criteria. The method further includes determining whether an additional degree of similarity between the features of the media item or the additional media item and features of one or more media items identified during a future time window satisfies the one or more similarity criteria. The method further includes, responsive to determining that the additional degree of similarity satisfies the one or more similarity criteria, determining that the one or more media items identified during the future time window also correspond to the emerging media trend.

In some implementations, determining that the media item or the additional media item satisfies the one or more template criteria includes determining that a number of common features of the media item or the additional media item and other media items corresponding to the media trend is larger than the number of common features of the other media items. The method further includes determining that a value of one or more engagement metrics representing user engagement with the media item or the additional media item is larger than a value of the one or more engagement metrics for the other media items.

In some implementations, the one or more embeddings representing the features of the media item include at least one of an audiovisual embedding that represents audiovisual features of the media item or a textual embedding that represents a textual feature of the media item.

In some implementations, the audiovisual features of the media item include at least one of: a scene depicted by a sequence of video frames of the media item, an object of the scene depicted by the sequence of video frames, at least one of an action, a motion, or a pose of the object of the scene, one or more colors included in the scene, one or more lighting features associated with the scene, a pitch of an audio signal of the media item, a timbre of the audio signal, a rhythm of the audio signal, speech content of the audio signal, speaker characteristics associated with the audio signal, environmental sounds associated with a scene of the media item, spectral features of the audio signal, or temporal dynamics of the audio signal. The textual features of the media item include at least one of a title associated with the media item, a description associated with the media item, a keyword associated with the media item, or a transcript associated with the media item.

In some implementations, generating the one or more embeddings includes obtaining a video embedding representing visual features of a sequence of video frames of the media item. The method further includes obtaining an audio embedding representing audio features of the sequence of video frames. The method further includes obtaining a textual embedding representing textual features associated with content of the sequence of video frames. The method further includes performing one or more concatenation operations to concatenate the video embedding and the audio embedding with the textual embedding. The method further includes, responsive to obtaining an output of the one or more concatenation operations, performing one or more attention pooling operations to the obtained output. An output of the one or more attention pooling operations includes the one or more embeddings.

In some implementations, providing the indication of the emerging media trend for presentation to the user includes updating a user interface (UI) of the client device to include one or more UI elements indicating that at least one of the media item or the one or more additional media items are associated with the media trend.

In some implementations, the method further includes, responsive to detecting a user interaction with at least one of the UI elements, providing the user with access to content of one or more of the at least one of the media item or the one or more additional media items, or one or more other media items corresponding to the emerging media trend.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example media item manager, and an example trend engine, in accordance with implementations of the present disclosure.

FIG. 3 is a block diagram of an example trend engine and an example anomaly engine, in accordance with implementations of the present disclosure.

FIG. 4 is a block diagram of an example method for real-time identification of media trends at a content sharing platform.

FIG. 5 illustrates an example of generating an embedding for media trend detection of content sharing platforms, in accordance with implementations of the present disclosure.

FIG. 6 is a block diagram of an illustrative predictive system, in accordance with implementations of the present disclosure.

FIG. 7 is a block diagram illustrating an exemplary computer system, in accordance with implementations of the present disclosure.

### DETAILED DESCRIPTION OF THE DRAWINGS

Aspects of the present disclosure generally relate to the real-time identification of media trends at a content sharing platform. A platform (e.g., a content sharing platform) can enable users to share media items (e.g., video items, audio items, etc.) with other users of the platform. Some media items may be part of, or otherwise associated with, a media trend. A media trend refers to a phenomenon in which a set of media items share a common format or concept and, in some instances, are widely shared among users of the platform. Media items associated with a media trend may share common visual features (e.g., dance moves, poses, actions, etc.), common audio features (e.g., songs, sound bites, etc.), common metadata (e.g., hashtags, titles, etc.), and so forth. One example of a media trend is a dance challenge trend, in which associated media items depict users performing the same or similar dance moves to a common audio signal.

Users may upload a significantly large number of media items to the platform each day (e.g., hundreds of thousands, millions, etc.). Given the large volume of uploaded media items, it can be challenging for the platform to perform media characterization tasks, such as detecting media trends among these media items and/or previously uploaded media items. For example, on a given day, multiple users may upload media items to the platform that share a common format or concept. Users of the platform may want to be informed of new media trends that emerge on the platform and/or which media items are part of a particular media trend (e.g., so that users can participate in the media trend by uploading a media item sharing the common format or concept of the trend). It can be difficult for the platform to identify, among the large number of media items uploaded by users each day, whether a new media trend has emerged and/or which media items are associated with the media trend.

Some conventional systems detect media trends in uploaded media items based on audiovisual features of the media items and/or user-provided metadata. For example, a conventional platform may detect that a significant number of media items uploaded within a particular time period share a common audio signal (e.g., a common song). The platform may determine whether metadata (e.g., titles, captions, hashtags, etc.) provided by users associated with such media items share common features (e.g., common words in the title or caption, common hashtags, etc.) and, if so, may determine that such media items are associated with a media trend. In an illustrative example, the platform may determine that media items including the song titled “I love to dance” are each associated with the common hashtag “#lovetodancechallenge.” Therefore, the platform may detect that a media trend has emerged and that such media items are associated with the detected media trend. Upon detecting the media trend, the platform may associate each newly uploaded media item containing the common song and/or associated with the hashtag with the media trend and, in some instances, may provide a notification to users accessing such media items.

As indicated above, users can upload a substantial number of media items to a platform each day. Identifying media items that share common audiovisual features and determining, based on user-provided metadata, whether such media items are associated with a new or existing media trend can involve significant computing resources (e.g., processing cycles, memory space, etc.). In some cases, a large proportion of uploaded media items may share common audiovisual features and some metadata features, yet may not be related to the same media trend. Relying solely on common user-provided metadata for media trend detection may prevent a platform from accurately determining whether a set of media items belong to the same media trend or whether the items, despite some similarities, are unrelated. Furthermore, media trends may be created and/or evolve multiple times within a given time period. Accordingly, media items associated with a media trend that are uploaded earlier in the time period may have different user-provided metadata than those uploaded later (e.g., due to the evolution of the media trend during the time period). Consequently, conventional platforms may be unable to accurately detect that both earlier and later uploaded media items are part of the same media trend. In such cases, the system is unable to accurately notify users of the media trend or identify which media items are part of the trend, and computing resources consumed to identify the media trend are wasted. Further, a user that wishes to participate in a media trend may spend additional time searching for media trends on the platform (e.g., using a user interface of a client device), which may further consume computing resources. These resources are then unavailable for other system processes, thereby increasing overall latency and decreasing system efficiency.

Implementations of the present disclosure address the above and other deficiencies by providing methods and systems for real-time identification of media trends at a content sharing platform. A user of the platform can provide a media item (e.g., via a client device) for sharing with other users of the platform. The platform may receive the media item during a current time window. The platform can generate one or more embeddings representing features of the media item. In some embodiments, the one or more embeddings can include video embeddings representing visual features of a sequence of video frames of the media item. A video embedding refers to a representation of video features of a media item in a low-dimensional vector space. The visual features represented by the video embeddings can include, for example, spatial features (e.g., detected objects, people or scenery, shapes, colors, textures, etc.), temporal features (e.g., how the objects move or change over time), scene context features (e.g., an environment of a scene, background information of the video content), and so forth. In other or similar embodiments, the one or more embeddings can include audio embeddings representing audio features of the sequence of video frames. An audio embedding refers to a representation of an audio signal of a media item in a low-dimensional space. Audio features of a media item can include, for example, pitch, timbre, rhythm, speech content (e.g., phonemes, syllables, word, etc.), speaker characteristics, environmental sounds, spectral features (e.g., frequency content), temporal dynamics (e.g., how sound evolves overtime), and so forth. In yet other or similar embodiments, the one or more embeddings can include textual embeddings representing textual features of content of the media item. A textual embedding refers to a representation of textual data or information pertaining to the media item content in a low-dimensional space. Textual features can include, for example, a title of the media item, a description of the media item, a keyword of the media item, a transcript of the media item, and so forth.

The platform can identify embedding(s) generated for one or more additional media items received by the platform during the current time window and can determine whether a degree of similarity between the features of the media item and features of the additional media item(s) satisfy one or more similarity criteria based on the embedding(s). For example, the platform can compare the embeddings generated for the media item to the embeddings for the additional media item(s) and determine whether a number of embeddings for the media item that match embeddings for the additional media item exceed a threshold number. Matching embeddings between the media item and the additional media item(s) can represent matching or corresponding features between the media item and the additional media item(s), in some embodiments.

Upon determining that the similarity criteria are satisfied, the platform can determine that the media item and the one or more additional media items correspond to an emerging media trend of the platform. In some embodiments, the platform can determine that the media item and the additional media item(s) correspond to the emerging media trend based on one or more outputs of an anomaly engine associated with the platform. An anomaly engine can include or otherwise correspond to a statistical analytics tool that generates time series data for content of the platform by monitoring and recording metrics associated with the content over discrete intervals. The content monitored by the anomaly engine can include content of media items, as described above, and/or content associated with other types of applications or features of the platform. For example, the content monitored by the anomaly engine can include content of electronic documents associated with the platform, content of electronic messages (e.g., electronic mail (e-mail) messages, chat messages, etc.), content of user queries provided for an artificial intelligence (AI) model of platform, and so forth. In some embodiments, the anomaly engine can monitor, for content of media items engagement events associated with each respective media item. An engagement event can include, for example, a view or access of the media item, an endorsement (e.g., a “like”) or a dissuasion (e.g., a “dislike”) associated with the media item, a comment provided for the media item, distribution (e.g., sharing) of the media item between one or more users of the platform, an amount of time spent watching or consuming the media item by users of the platform, and so forth.

In some embodiments, the platform can obtain engagement data associated with the media item and/or the additional media item(s) during the current time period and can provide the obtained engagement data as an input to the anomaly engine. The platform can additionally or alternatively provide the embedding(s) generated for the media item and/or the additional media item(s), as described above. The anomaly engine can generate time series data that reflect, during the time period, a fluctuation or evolution of the user engagement with respect to the media item and/or the additional media item(s) throughout the current time period. The anomaly engine may organize or otherwise aggregate the fluctuating engagement data based on media items that share common embedding(s) (e.g., representing common features of such media items). The platform can obtain one or more outputs of the anomaly engine, which can include values representing engagement metrics for the media item and/or the additional media item(s), which may be aggregated in view of the common embeddings shared between the media item and/or the additional media item(s).

The platform can determine whether the media item and the additional media item(s) correspond to an emerging media trend by determining whether the values of the engagement metrics included in the output(s) of the anomaly engine satisfy one or more engagement criteria. For example, the platform can determine that the media item and the additional media item(s) correspond to the emerging media trend by determining that the values of the engagement metrics exceed a threshold value. Upon determining that the media item and the additional media item(s) correspond to the emerging media trend, the platform can provide a notification of the emerging media trend to users of the platform. For example, upon receiving a request to access the media item and/or the additional media item(s), the platform can provide a client device that provided the request with a notification that the media item and/or the additional media item(s) correspond to the media trend, for presentation to a user of the client device. In another example, the platform can provide users with access to a set of media trends detected by the platform, which can include the emerging media trend. Upon detection of engagement of an element of a user interface (UI) that corresponds to the emerging media trend, the platform can update a UI of the platform to include, for presentation to a user, the media item and/or the additional media item(s), as well as other media items identified as corresponding to the emerging media trend, in some embodiments.

Aspects of the present disclosure provide techniques for real-time identification of media trends at a content sharing platform. As described herein, the platform can continuously evaluate media items provided by users to determine whether such media items correspond to an existing media trend (e.g., detected during a prior time window) or an emerging media trend (e.g., detected during a current time window). The platform can provide users with a notification of the existing and emerging media trends upon detection, which can be in real-time or approximately real-time. Further, the platform can detect, based on output(s) of the anomaly engine, whether and/or when user engagement with media items of a particular media trend declines and can accordingly remove the designation of the media trend in real-time or approximately real time.

By determining whether a media item is part of a media trend based on the audiovisual and textual features of the media item (e.g., instead of user-provided metadata for the media items), the system is able to more accurately determine whether the content of the media item matches or approximately matches content of other media items identified as part of the trend, in accordance with the common format or concept of the media trend. Further, by evaluating whether media items are part of a media trend based on the audiovisual and textual features, the system is more quickly able to detect when a new media trend has emerged and/or has evolved, as outputs of the AI model can indicate to the system that a growing set of media items sharing common audiovisual and/or textual features is identified. Therefore, the system is able to more accurately and quickly identify and surface media trends to users, thereby reducing the amount of computing resources wasted by the system to detect such media trends and improving the overall efficiency and reducing the overall latency of the system.

Further, as described above, the system generates audiovisual embeddings and textual embeddings representing the audiovisual and textual features of a media item, which can be used to perform a variety of media characterization tasks, including media trend detection. Using the audiovisual and textual embeddings, the system is able to characterize media items more accurately at a platform in real time, which can enable the platform to detect media trends, determine a degree of interest in content of a media item, determine an image quality and/or an audio quality of a media item, etc. more accurately and efficiently. Thus, the system is able to provide users with media items of interest and/or of higher quality, and the system consumes fewer resources providing users with media items they are not interested in and/or of lower quality. Further, embodiments of the present disclosure can be applied to a variety of different media characterization tasks, and therefore the system does not consume excess resources performing such tasks based on individual data sets, which can decrease an overall amount of memory space and processing cycles consumed by the system. Such computing resources are made available to other processes, which further improves the latency and efficiency of the overall system.

Embodiments of the present disclosure go beyond the mere application of existing artificial intelligence models to a new data environment. Specifically, embodiments of the present disclosure introduce a tightly-coupled, multi-stage processing technique that enables the finding of new patterns in different types of media signals and mitigating computing, memory, and/or network bandwidth bottlenecks that arise when the volume of user-generated content increases. Embodiments of the present disclosure enable a platform to synchronize cross-modal embedding generation techniques with temporal anomaly detection techniques so to enable the platform to identify an emerging media trend in the precise time window when media items satisfy statistically significant engagement thresholds. Such techniques enable real-time trend detection which are not possible using standard AI models on their own. Additionally, embodiments of the present disclosure provide for dynamically adjusting the embedding space of a media corpus with the anomaly engine's time-series data, improving precision and speed by recalibrating similarity thresholds.

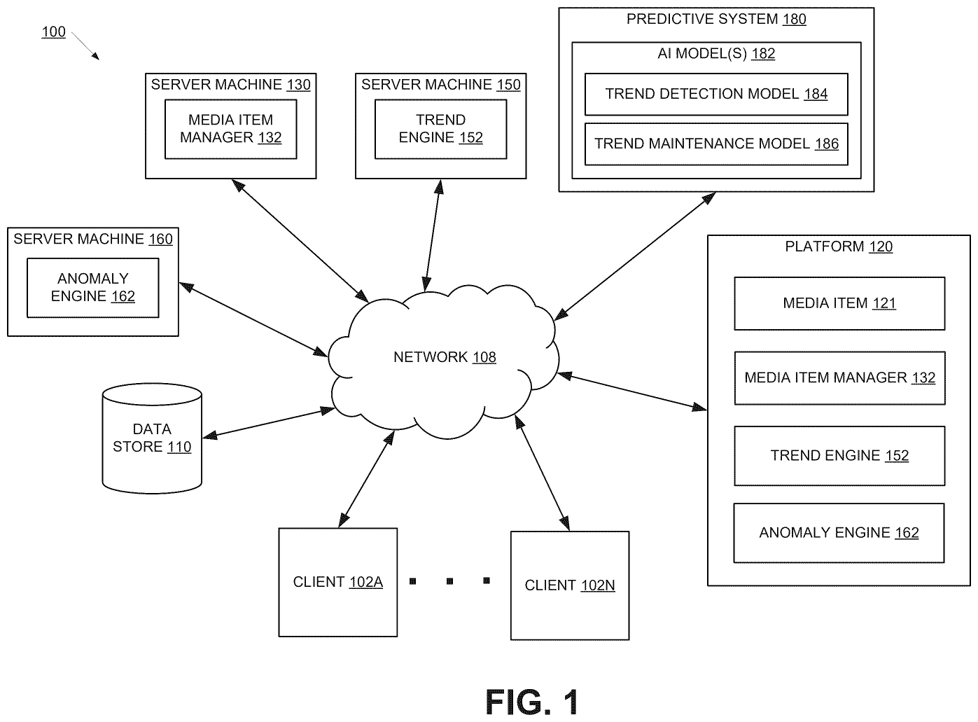

FIG. 1 illustrates an example system architecture 100, in accordance with implementations of the present disclosure. The system architecture 100 (also referred to as “system” herein) includes client devices 102A-N, a data store 110, a platform 120, and/or one or more server machines (e.g., server machine 130, server machine 150, server machine 160, etc.) each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N (collectively and individually referred to as client device(s) 102 herein) can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

Platform 120 can include a media item manager 132 that is configured to manage media items 121 and/or access to media items 121 of platform 120. As described above, users of platform 120 can provide media items 121 (e.g., long-form media items, short-form media items, etc.) to platform 120 for access by other users of platform 120. As described herein, a user that creates or otherwise provides a media item 121 for access by other users is referred to as a “creator.” A creator can include an individual user and/or an enterprise user that creates content for or otherwise provides a media item 121 to platform 120. A user that accesses a media item 121 is referred to as a “viewer,” in some instances. The user can provide (e.g., upload) the media item 121 to platform 120 via a user interface (UI) of a client device 102, in some embodiments. Upon providing the media item 121, media item manager 132 can store the media item 121 at data store 110 (e.g., at a media item corpus or repository of data store 110).

In some embodiments, media item manager 132 can store the media item 121 with data or metadata associated with the media item 121. Data or metadata associated with a media item 121 can include, but is not limited to, information pertaining to a duration of media item 121, information pertaining to one or more characteristics of media item 121 (e.g., a type of content of media item 121, a title or a caption associated with the media item, one or more hashtags associated with the media item 121, etc.), information pertaining to one or more characteristics of a device (or components of a device) that generated content of media item 121, information pertaining to a viewer engagement pertaining to the media item 121 (e.g., a number of viewers who have endorsed the media item 121, comments provided by viewers of the media item, etc.), information pertaining to audio of the media item 121 and/or associated with the media item 121, and so forth. In some embodiments, media item manager 132 can determine the data or metadata associated with the media item 121 (e.g., based on media item analysis processes performed for a media item received by platform 120). In other or similar embodiments, a user (e.g., a creator, a viewer, etc.) can provide the data or metadata for the media item 121 (e.g., via a UI of a client device 102). In an illustrative example, a creator of the media item 121 can provide a title, a caption, and/or one or more hashtags pertaining to the media item 121 with the media item 121 to platform 120. The creator can additionally or alternatively provide tags or labels associated with the media item 121, in some embodiments. Upon receiving the data or metadata from the creator (e.g., via network 104), media item manager 132 can store the data or metadata with media item 121 at data store 110.

As used herein, a hashtag refers to a metadata tag that is prefaced by the hash symbol (e.g., “#”). A hashtag can include a word or a phrase that is used to categorize content of the media item 121. As indicated above, in some embodiments, a creator or user associated with a media item 121 can provide platform 120 with one or more hashtags for the media item 121. In other or similar embodiments, media item manager 132 and/or another component of platform 120 or of another computing device of system 100 can derive or otherwise obtain a hashtag for media item 121. It should be noted that the term “hashtag” is used throughout the description for purposes of example and illustration only. Embodiments of the present disclosure can be applied to any type of metadata tag, regardless of whether such metadata tag is prefaced by the hash symbol.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

Trend engine 152 can detect one or more media trends among media items 121 of platform 120 and/or can determine whether a respective media item 121 is associated with a media trend. A media trend refers to a phenomenon in which content of a set of media items share a common format or concept and, in some instances, are shared widely among users of platform 120. Media items that are associated with a media trend may share common visual features (e.g., dance moves, poses, actions, etc.), common audio features (e.g., songs, sound bites, etc.), common metadata (e.g., titles, captions, hashtags, etc.), and so forth. In some instances, a creator can upload to platform 120 (e.g., via a UI of a client device 102) a media item 121 including content having a particular format or concept for sharing with other users of platform 120. One or more other users of platform 120 can access the creator's media item 121 and, in some instances, may be inspired to create their own media items 121 that share the particular format or concept of the accessed media item 121. In some instances, a significantly large number of users (e.g., hundreds, thousands, millions, etc.) can create media items 121 sharing the particular format or concept of the original creator's media item 121. In accordance with embodiments described herein, trend engine 152 may detect such media items 121 sharing the particular format or concept as a media trend. Examples of media trends can include, but are not limited to, dance trends or dance challenge trends, memes or pop culture trends, branded hashtag challenge trends, and so forth. For purposes of example and illustration only, some embodiments and examples herein are described with respect to a dance trend or a dance challenge trend. It should be noted that such embodiments and examples are not intended to be limiting and embodiments of the present disclosure can be applied to any kind of media trend for any type of media item (e.g., a video item, an audio item, an image item, etc.).

As described herein, trend engine 152 may detect a media trend that originated based on a media item 121 provided by a particular creator (or group of creators). Such media item 121 is referred to herein as a “seed” media item 121. In some instances, the common format or concept shared by media items 121 of a trend may deviate from the original format or concept of the seed media item 121 that initiated the trend. In some embodiments, trend engine 152 may identify a media item 121 (or a set of media items) associated with the media trend of which the common format or concept is determined to initiate the deviation from the original format or concept of the seed media item 121. In some embodiments, such identified media item 121 may be designated as the seed media item 121 for the media trend. In other or similar embodiments, the original media item 121 and the identified media item 121 may both be designated as seed media items 121 for the media trend.

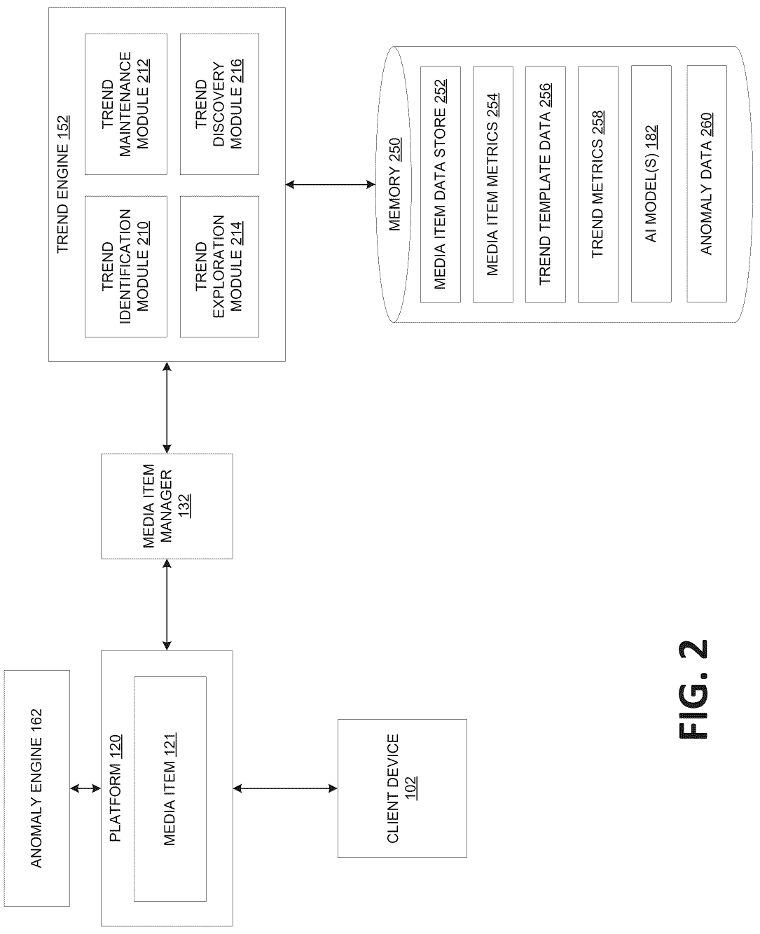

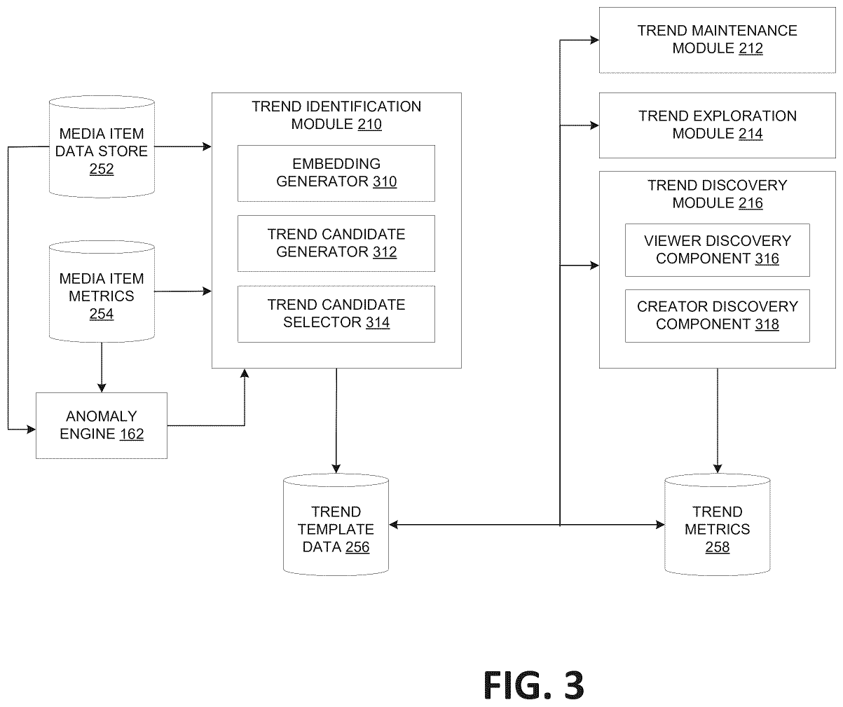

In some embodiments, trend engine 152 may determine one or more features (e.g., video features, audio features, textual features, etc.) of media items 121 of a media trend that are specific or unique to the format or concept of the media trend. Such features may define a template for the media trend for which other media items 121 replicating the media trend are to include. As described herein, trend engine 152 can determine such features and can store data indicating such features as trend template data (e.g., trend template data 256 of FIGS. 2 and 3). Trend engine 152 can determine whether subsequently uploaded media items 121 are part of a media trend by comparing features of the uploaded media items 121 to features indicated by the trend template data, in accordance with embodiments described herein. Further details regarding trend engine 152 and detecting media trends are provided herein with respect to FIGS. 2-6.

As illustrated in FIG. 1, system 100 can also include a predictive system 180, in some embodiments. Predictive system 180 can implement one or more artificial intelligence (AI) and/or machine learning (ML) techniques for performing tasks associated with media trend detection. In some embodiments, predictive system 180 can train one or more AI models 182 (e.g., a machine learning model) to detect whether a new media trend has emerged with respect to media items 121 uploaded to platform 120 and/or whether a media item 121 uploaded to platform 120 is part of a detected media trend. For purposes of explanation and example only, an AI model 182 that is trained to detect an emerging media trend is referred to as a trend detection model 184 and an AI model 182 trained to determine whether a media item 121 uploaded to platform 120 is part of a detected media trend is referred to as a trend maintenance model 186. It should be noted that while in some embodiments, functionalities of the trend detection model 184 may be separate from the functionalities of the trend maintenance model 186. However, in other or similar embodiments, functionalities of the trend detection model 184 and the trend maintenance model 186 can be performed by the same AI model 182. Further details regarding inference and training of the AI models are provided below.

In some embodiments, platform 120 can include an anomaly engine 162 that can detect anomalies of content and/or properties of content provided by users of platform 120. In some embodiments, anomaly engine 162 can be included in or otherwise correspond a real-time forecasting system that monitors, analyzes, and predicts relationships between content properties in real-time, based on a pre-built static index of historical attributes aggregated over time. Anomaly engine 162 may construct the static index by aggregating and storing metadata and/or derived features (e.g., views, engagement rates, topics, sentiments, virality scores, media types, etc.) from content items provided by users over a particular time window. As new content is uploaded or consumed by users of platform 120, anomaly engine 162 can perform real-time correlation analysis between the live content's features and the historical index, which can include identifying statistically significant associations between current content features historical patterns. Anomaly engine 162 can identify trends or anomalies of the live content's features by comparing live metrics against indexed norms. It should be noted that anomaly engine 162 can detect anomalies of content of media items 121 uploaded to platform 120 and/or other types of content (e.g., content of electronic documents, electronic messages, user queries directed to AI model(s) 182, etc.).

It should be noted that although FIG. 1 illustrates trend engine 152 as part of platform 120, in additional or alternative embodiments, trend engine 152 can reside on one or more server machines or systems that are remote from platform 120 (e.g., server machine 130, server machine 150, server machine 160, predictive system 180). It should be noted that in some other implementations, the functions of server machines 130, 150, 160 predictive system 180 and/or platform 120 can be provided by a fewer number of machines. For example, in some implementations, components and/or modules of any of server machines 130, 150, 160 and/or predictive system 180 may be integrated into a single machine, while in other implementations components and/or modules of any of server machines 130, 150, 160 and/or predictive system 180 may be integrated into multiple machines. In addition, in some implementations, components and/or modules of any of server machines 130, 150, 160 and/or predictive system 180 may be integrated into platform 120.

In general, functions described in implementations as being performed by platform 120 and/or any of server machines 130, 150, 160 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120, an example media item manager 132, and an example trend engine 152, in accordance with implementations of the present disclosure. As described above, platform 120 can provide users (e.g., of client devices 102) with access to media items 121. Media items 121 can include long-form media items and/or short-form media items. In some embodiments, a user (e.g., a creator) can provide a media item 121 to platform 120 for access by other users (e.g., viewers) of platform 120. Media item manager 132 can identify media items 121 of interest and/or relevant to users (e.g., based on a user access history, a user search request, etc.) and can provide the users with access to the identified media items 121 via client devices 102. As described herein, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends.

As illustrated in FIG. 2, trend engine 152 can include a trend identification module 210, a trend maintenance module 212, a trend exploration module 214, and/or a trend discovery module 216. Trend identification module 210 can perform one or more operations associated with trend identification, which can include identification of one or more media items 121 that may initiate or otherwise correspond to an emerging media trend and/or determine trend template data for a detected media trend. Trend maintenance module 212 can perform one or more operations associated with trend maintenance, including detecting newly uploaded media items 121 that correspond to a detected media trend and, if needed, updating trend template data 256 for a detected trend based on an evolution of the media trend over time. Trend exploration module 214 can perform one or more operations associated with trend exploration, which can include determining a context and/or a purpose of the media trend and, in some embodiments, identifying features of media items 121 of the media trend of which particular audiences of users are particularly interested. Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. It should be noted that trend engine 152 can include one or more additional or alternative modules, in some embodiments. It should also be noted that although some operations or functionalities are described with respect to particular modules of trend engine 152, any of trend identification module 210, trend maintenance module 212, trend exploration module 214, trend discovery module 216, and/or any alternative or additional modules of trend engine 152 can perform any operations pertaining to trend detection and surfacing, as described herein. Details regarding trend detection by trend engine 152 are provided below with respect to FIGS. 3-5.

In some embodiments, platform 120, media item manager 132, trend engine 152, and/or anomaly engine 162 can be connected to memory 250 (e.g., via network 108, via a bus, etc.). Memory 250 can correspond to one or more regions of data store 110, in some embodiments. In other or similar embodiments, one or more portions of memory 250 can include or otherwise correspond any memory of or connected to system 100. Data, data items, data structures, and/or models stored at memory 250, as depicted by FIG. 2, are described in conjunction with FIGS. 3-6.

FIG. 3 is a block diagram of an example trend engine 152 and an example anomaly engine 162, in accordance with implementations of the present disclosure. Trend engine 152 can include or otherwise correspond to trend engine 152 of FIGS. 1-2. As described above, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends. Anomaly engine 162 can detect anomalies of content and/or properties of content (e.g., media item content or other types of content) provided by users of platform 120.

Media items 121 evaluated by trend engine 152 can be stored at media item data store 252 of memory 250, in some embodiments. In an illustrative example, a user of a client device 102 can provide a media item 121 to platform 120 to be shared with other users of platform 120. Upon receiving the media item 121, media item manager 132 (or another component of platform 120) may store the media item 121 at media item data store 252. In some embodiments, media item data store 252 can additionally or alternatively store metadata associated with a media item 121 (e.g., a title of the media item 121, a description of the media item 121, etc.). Metadata for a media item 121 may be received by platform 120 with the media item 121 and/or may be determined by platform 120 (e.g., after receiving the media item 121). Trend engine 152 may evaluate a respective media item 121 for association with a media trend at any time after the media item 121 is received by platform 120. For example, upon receiving the media item 121, trend engine 152 may perform one or more operations described herein to determine whether the media item 121 is associated with a media trend (e.g., prior to or while users of platform 120 access media item 121). In another example, platform 120 may provide users with access to media item 121 and, after a period of time (e.g., hours, days, weeks, months, etc.), trend engine 152 may evaluate whether the media item 121 is associated with a media trend, as described herein.

As described above, trend identification module 210 can perform one or more operations associated with trend identification. Trend identification refers to the detection of media trends among media items 121 of platform 120 and/or determining whether a newly uploaded media item 121 corresponds to a previously detected media trend. In some embodiments, trend identification module 210 can include an embedding generator 310, a trend candidate generator 312, and/or a trend candidate selector 314. Embedding generator 310 can generate one or more embeddings representing features of a media item 121. An embedding refers to a representation of data (e.g., usually high-dimensional and complex) in a lower-dimensional vector space. Embeddings can transform complex data types (e.g., text, images, audio, etc.) into numerical vectors that can be processed and analyzed more efficiently by AI models or other such algorithms (e.g., AI model(s) 182). In some embodiments, embedding generator 310 can generate a set of audiovisual embeddings that represent audiovisual features of a media item 121. Embedding generator 310 can additionally or alternatively generate a set of textual embeddings that represent textual features of the media item 121. The set of audiovisual embeddings can represent one or more audiovisual features of the media item 121 and the set of textual embeddings can represent one or more textual features of the media item 121.

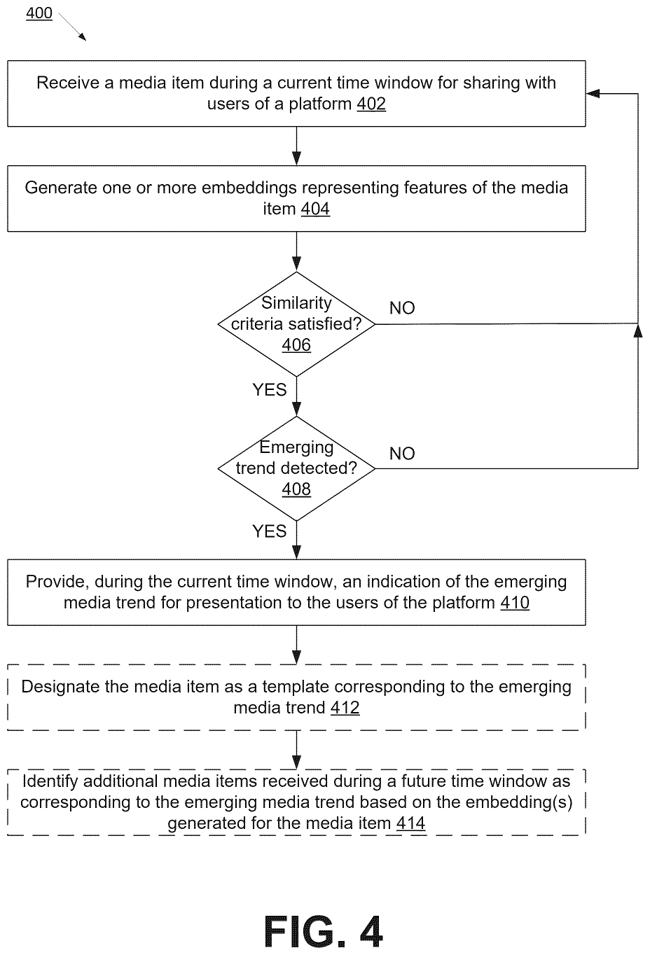

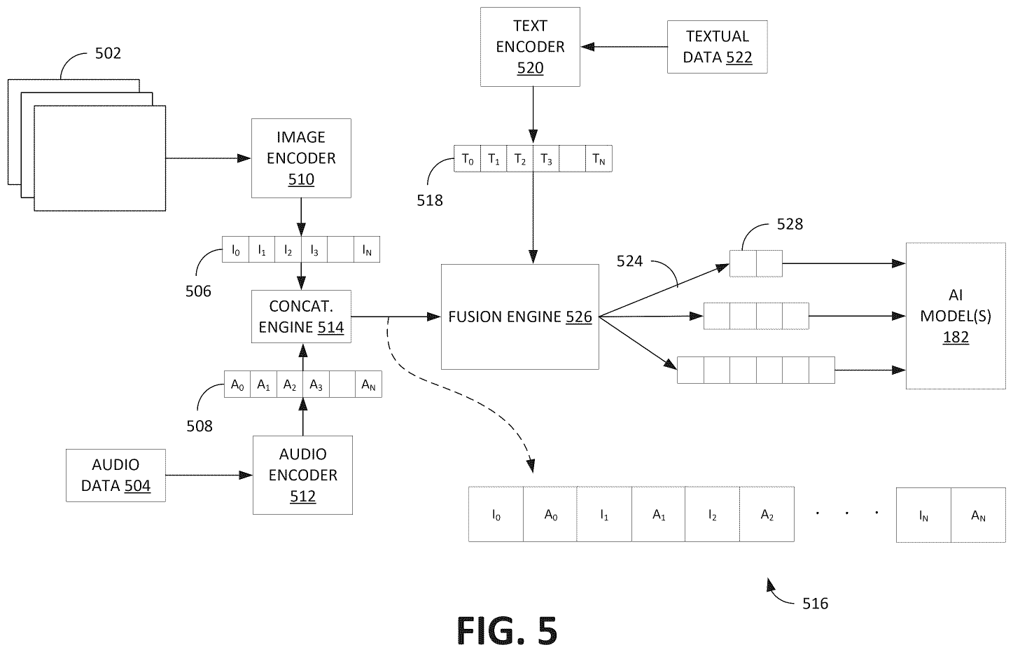

In some embodiments, embedding generator 310 can generate the set of audiovisual embeddings by obtaining video embeddings and audio embeddings for the media item 121 and performing one or more operations to fuse the video embeddings with the audio embeddings. The video embeddings can be obtained based on one or more outputs of an image encoder (e.g., a vision transformer, a convolutional neural network, etc.) and can represent video features of one or more frames of the media item 121, including spatial features (e.g., detected objects, people or scenery, shapes, colors, textures, etc.), temporal features (e.g., how the objects move or change over time), scene context features (e.g., an environment of a scene, background information of the video content), and so forth. The audio embeddings can be obtained based on one or more outputs of an audio encoder (e.g., an audio spectrogram transformer, etc.) and can represent audio features of the one or more frames, including pitch, timbre, rhythm, speech content (e.g., phonemes, syllables, word, etc.), speaker characteristics, environmental sounds, spectral features (e.g., frequency content), temporal dynamics (e.g., how sound evolves overtime), and so forth. Embedding generator 310 can generate the set of audiovisual embeddings by performing one or more concatenation operations with respect to the video embeddings and the audio embeddings and, in some embodiments, performing one or more attention pooling operations with respect to the concatenated video and audio embeddings. Embedding generator 310 can generate the set of textual embeddings for the media item 121 by providing textual data associated with the media item 121 (e.g., a title, a description, one or more keywords or hashtags, a transcript generated based on one or more audio signals associated with the media item 121, etc.) as an input to a text encoder (e.g., a bidirectional encoder representations from transformations (BERT) encoder, a robustly optimized BERT approach (RoBERTa) encoder, a generative pre-trained transformer (GPT) encoder, a text-to-text transfer transformer (T5) encoder, etc.). Further details regarding generating the audiovisual embeddings and/or the textual embeddings are provided herein with respect to FIGS. 4-5.

In some embodiments, embedding generator 310 can store the embeddings generated or otherwise obtained for a media item 121 at media item data store 252 (e.g., with metadata for the media item 121). In other or similar embodiments, embedding generator 310 can store the embeddings for a media item 121 at another region of memory 250 or at another memory of or accessible to components of system 100.

Trend candidate generator 312 can identify one or more media items 121 of media item data store 252 that are candidates for association with a media trend. In some embodiments, trend candidate generator 312 can provide audiovisual embeddings and textual embeddings generated for media items 121 of media item data store 252 as an input to one or more AI models 182. The AI model(s) 182 can include a trend detection model 184, which can be trained to perform one or more clustering operations to identify clusters or groups of media items 121 sharing common or similar video and/or audio features, in view of their embeddings. In some embodiments, the one or more clustering operations can include a k-means clustering operation, a hierarchical clustering operation, gaussian mixture model (GMM) operation, or any other such type of clustering operation. Trend candidate generator 312 can obtain one or more outputs of the trend detection model 184, which can indicate a distance between each of a set of media items 121 of an identified cluster or group. The distance indicated by the model outputs can indicate a distance between the visual or audio features for each of the set of media items 121, in view of the textual features associated with such media items 121. Trend candidate generator 312 can determine that the set of media items 121 indicated by the output(s) of the trend detection model 184 are candidates for association with a media trend by determining that the distance of the output(s) satisfies one or more distance criteria (e.g., falls below a distance threshold).

Trend candidate generator 312 can identify multiple sets of media items 121 that are candidates for different media trends, in accordance with embodiments described above. Trend candidate selector 314 can select a respective set of media items 121 identified by trend candidate generator 312 that define or are otherwise associated with a media trend of platform 120. In some embodiments, trend candidate selector 314 can select a respective set of media items 121 to be associated with a media trend by determining that the respective set of media items 121 satisfy one or more media trend criteria. The media trend criteria can be defined by a developer or operator of platform 120 and can relate to commonalties of detected media trends. In an illustrative example, a media trend criterion can be that a set of media items 121 identified as a candidate for a dance challenge media trend include a song that has characteristics associated with songs for other dance challenge media trends (e.g., high tempo, upbeat lyrics, etc.). A developer or operator of platform 120 can provide the media trend criteria to trend candidate selector 314, in some embodiments, and trend candidate selector 314 can select a respective set of media items 121 for association with a media trend by determining whether the set of media items 121 satisfies the media trend criteria. In other or similar embodiments, media trend selector 314 can provide, to a client device 102 associated with the developer or operator, an indication of one or more sets of media items identified as media trend candidates. The developer or operator can provide an indication a set of media items that satisfies the media trend criteria via a UI of the client device 102, in some embodiments.

Upon selecting or otherwise identifying a respective set of media items that are associated with a media trend, trend candidate selector 314 can determine trend template data 256 for the media trend based on data associated with each of the set of media items. Trend template data 256 can include embeddings indicating one or more common audio, video, and/or textual features of each of the set of media items that are unique to the media trend (e.g., compared to other media items 121 that are not associated with the trend). In some embodiments, trend candidate selector 314 can identify audiovisual embeddings and/or the textual embeddings representing one or more visual features, audio features, and/or textual features that are common to each of the set of media items and can store such identified embeddings as trend template data 256 for media items 121 of the media trend.

In other or similar embodiments, trend candidate selector 314 can determine a particular media item 121 of the set of media items that originated the media trend and/or best represents the media trend. Trend candidate selector 314 can identify audiovisual embeddings and/or textual embeddings representing visual features, audio features, and/or textual features for the particular media item 121 and store such identified embeddings at memory 250 as trend template data 256. Trend candidate selector 314 can determine that the particular media item 121 originated the media trend by determining that such media item 121 was provided to platform 120 before the other media item 121 of the media trend, in some embodiments. In other or similar embodiments, trend candidate selector 314 can determine that such media item 121 originated the media trend based on creation journey data associated with the media item 121 and/or other media items 121 of the media trend. In some embodiments, creation journey data can be provided by or otherwise determined for creators of media items 121 and can indicate one or more media items 121 of platform 120 that inspired the creator to upload a respective media item 121. For example, a user of platform 120 can access a first media item of another user and determine to create and provide to platform 120 a second media item with content matching or approximately matching the content of the first media item. In such example, the first media item may be determined to be part of the “creation journey” of the second media item, as content of the first media item inspired the creation of the second media item. In some embodiments, a creator may provide an indication of media items 121 that are part of the “creation journey” of a provided media item 121 via a UI of a client device 102. Such indication can be included in creation journey data associated with the media item 121 (e.g., and stored as metadata at media item data store 252). In other or similar embodiments, trend candidate selector 314 (and/or another component of trend engine 152 or platform 120) can identify media items 121 that may be included in a creation journey associated with a media item 121 provided by a creator by identifying media items 121 that the creator accessed prior to providing their media item 121. In some embodiments, trend candidate selector 314 can parse creation journey data associated with each of the set of media items identified for the media trend and can identify a particular media item 121 that satisfies one or more creation journey criteria (e.g., is included in a threshold number of creation journeys of the set of media items) as best representing the media trend.

As indicated above, trend maintenance module 212 can perform one or more operations associated with trend maintenance, including detecting newly uploaded media items 121 that correspond to a detected media trend and, if needed, updating trend template data 256 for the trend based on an evolution of the media trend over time. In some embodiments, platform 120 can receive a media item 121 from a client device of a creator for sharing with other users of the platform. Upon receiving the media item 121, embedding generator 310 may generate a set of audiovisual embeddings and/or a set of textual embeddings for the media item 121, as described herein. Trend maintenance module 212 can provide the generated embeddings for the media item 121 as an input to one or more AI models 182. In some embodiments, the one or more AI model(s) 182 can include a trend maintenance model 186, which can be trained to determine whether a media trend 121 uploaded to platform 120 is part of a detected media trend (e.g., detected by trend identification module 210). In some embodiments, trend maintenance module 212 can provide the embeddings for the media item 121 as an input to the trend maintenance model 186 and can obtain one or more outputs, which can indicate whether the media item 121 is associated with a detected media trend. Responsive to determining, based on the one or more outputs of the trend maintenance model 186, that the media item 121 is associated with a detected trend, trend maintenance module 212 can update media item data store 252 to include an indication that media item 121 is associated with the detected trend.

In some embodiments, trend maintenance module 212 may determine that one or more features (e.g., video feature, audio feature, etc.) of a user provided media item 121 may correspond to a feature of media items 121 associated with a detected media trend. In such embodiments, trend maintenance module 212 may identify the trend template data 256 associated with the detected media trend and may provide the embeddings of the identified trend template data 256 as an input to trend template model 186 (e.g., with the embeddings for the user provided media item 121. In such embodiments, trend maintenance model 186 can provide one or more outputs that indicate a distance between features of the user provided media item 121 and features indicated by the provided embeddings associated with the media trend. Trend maintenance module 212 can determine whether the user provided media item 121 is associated with the media trend by determining whether the distance indicated by the one or more outputs satisfies one or more distance criteria (e.g., falls below a distance threshold).

In some embodiments, prior to providing the embeddings for the user provided media item 121 and the embeddings associated with the media trend as an input to the trend maintenance model 186, trend maintenance module 212 can determine a degree of alignment between the embeddings of the user provided media item 121 and the embeddings associated with the media trend. For example, trend maintenance module 212 can provide the embeddings of the user provided media item 121 and the embeddings associated with the media trend as an input to an alignment function (e.g., a dynamic time warping function) and can obtain, based on one or more outputs of the alignment function, an indication of a degree of alignment between one or more visual features of the user provided media item 121 and visual features represented by the embeddings for the media trend. Trend maintenance module 212 can provide the indicated degree of alignment as an input to trend maintenance model 186, which can further inform trend maintenance model 186 of the similarities and/or distance between content of the user provided media item 121 and media items 121 of the media trend. In other or similar embodiments, trend maintenance model 186 can predict the degree of alignment between the embeddings provided as an input, and the output(s) of the trend maintenance model 186 can indicate the predicted degree of alignment.

As indicated above, trend maintenance module 212 can continuously compare features of newly uploaded media items 121 to features of media items 121 associated with detected media trends to determine whether such newly uploaded media items 121 are associated with a respective media trend. In some embodiments, trend maintenance module 212 can detect that a distance between features of media items 121 associated with a detected media trend and features of newly uploaded media items 121 determined to be associated with a media trend changes overtime. For example, trend maintenance module 212 can detect that a distance value included in the output(s) of trend maintenance module 212, while still satisfying the distance criteria, are increasing overtime. Such change can indicate to trend maintenance module 212 that the media trend may be evolving since the initial identification of the media trend. In some embodiments, trend maintenance module 212 may transmit an instruction to trend identification module 210 to perform one or more media trend identification operations with respect to the newly updated media items 121 of which the deviation from the media trend is detected. Trend identification module 210 can perform the media trend identification operations with respect to such media items 121 and can determine (e.g., based on the clustering operations performed by trend candidate generator 312) whether a new media trend is detected among such media items 121. In response to determining that the new media trend is detected, trend identification module 210 can update trend template data 256 associated with the media trend to include one or more features (e.g., visual features, audio features, textual features, etc.) for such media items 121. In some embodiments, trend maintenance module 212 can perform trend maintenance operations with respect to newly uploaded media items 121 based on the updated trend template data 256 for the media trend.

Trend exploration module 214 can perform one or more operations associated with trend exploration, which can include, in some embodiments, determining a context and/or a purpose of a detected media trend and/or identifying features of media items 121 of the detected media trend of which particular audiences of users are particularly interested. In some embodiments, trend exploration module 214 can determine the context and/or purpose of the detected media trend upon detection of the media trend. For example, trend identification module 210 can detect a new media trend among media items 121 of media item store 252, as described herein, but at the time of detection, trend engine 152 may be unaware of the context or purpose of the media trend. Trend exploration module 214 can compare features of trend template data 256 (e.g., as determined for the media trend by trend identification module 210) to features of media items 121 for other media trends for which the context or purpose is known. Upon determining that one or more features (e.g., visual features, audio features, etc.) indicated by the trend template data 256 corresponds to (e.g., matches or approximately matches) features for the media items 121 for the other media trends, trend exploration module 214 can determine that the context or purpose of the detected media trend matches the context or purpose of the other media trends. In an illustrative example, the features of the trend template data can indicate that the audio signal of media items 121 of a detected media trend includes a steady beat, a fast tempo, a high or medium degree of syncopation, and so forth. Trend exploration module 214 can compare these features to features of media items 121 associated with other media trends at platform 120 and can determine, based on the comparison, that features of the detected media trend match features of media items 121 for dance challenge trends. Therefore, trend exploration module 214 can determine that the context or purpose of the detected media trend is a dance challenge. In some embodiments, trend exploration module 214 can update trend template data 256 to include an indication of the determined context or purpose for the detected media trend.

Trend exploration module 214 can also collect trend metrics 258 for a respective media trend, which includes data indicating user engagement associated with media items 121 of a particular media trend. User engagement can include, but is not limited to, viewership engagement (e.g., a number of times the media item 121 has been watched, the amount of time users spend watching the media item 121, the percentage of users who watch the entire media item 121, etc.), interaction engagement (e.g., approval or disapproval expressions provided by users, comments provided by users, a number of times users have shared the media item 121 with other users, etc.), social engagement (e.g., mentions or tags associated with the media item 121 in social media posts or comments, etc.), user retention engagement (e.g., the number of users that rewatch the media item 121, etc.), interactive engagement (e.g., user engagement with polls or quizzes associated with the media item 121), feedback engagement (e.g., user responses in surveys, reviews, etc. associated with the media item 121), and so forth. In some embodiments, trend exploration module 214 can collect user engagement data for each media item 121 associated with a respective media trend 121 determined to be associated with a media trend and can aggregate the collected user engagement data for each media trend as one or more media trend metrics 258. In an illustrative example, a media trend metric 258 for a respective media trend can indicate a factor of component of user engagement across all media items 121 associated with the respective media trend. In some embodiments, trend metrics 258 can also include data or other information associated with the characteristics of users and/or client devices that are accessing and/or engaging with media items 121 of the media trend and/or are not accessing and/or engaging with media items 121 of the media trend.

In some embodiments, trend exploration module 214 can detect when a previously detected media trend has become inactive or unsuccessful. An inactive media trend refers to a media trend of which a degree or frequency of association with newly uploaded media items 121 within a particular time period falls below a threshold degree or a threshold frequency. An unsuccessful media trend refers to a media trend of which values of media trend metrics 258 (e.g., pertaining to user access and/or user engagement) satisfy one or more unsuccessful trend criteria. For example, trend exploration module 214 can determine that a media trend is unsuccessful upon determining that an aggregate number of users that have shared media items 121 of the media trend falls below a threshold number. In another example, trend exploration module 214 can determine that a media trend is unsuccessful upon determining that an aggregate number of disapproval expressions (e.g., “dislikes”) for media items 121 of the media trend exceeds a threshold number and/or an aggregate number of approval expressions (e.g., “likes”) for media items 121 of the media trend falls below a threshold number. Upon determining that a media trend has become inactive or unsuccessful, media item manager 132 (or another component or module of trend engine 152) can perform one or more operations to update trend template data 256 to indicate that the media trend is an inactive or an unsuccessful media trend. In some embodiments, trend engine 152 can remove trend template data 256 for the inactive or unsuccessful media trend from memory 250 based on the indication.

Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. As illustrated in FIG. 3, trend discovery module 216 can include a viewer discovery component 316 and/or a creator discovery component 318. As described herein, media item manager 132 can provide a user with access to media item 121 (e.g., upon receiving a request from a client device 102 of the user). In some embodiments, viewer discovery component 316 can detect that a media item 121 to be provided to a client device 102 is determined to be associated with a detected media trend, in accordance with previously described embodiments, and can provide a notification to the client device 102 (e.g., with the media item 121) indicating that the media item 121 is associated with the media trend. In some embodiments, viewer discover component 316 can also provide a user with an indication of one or more additional media items 121 associated with the media trend (e.g., in response to a request from the client device 102).

As described above, trend identification module 210 can identify one or more media items 121 that originated or created a media trend. In some embodiments, creator discovery component 318 can provide a notification to creators associated with the identified media item(s) 121 that their media item 121 is determined to have originated or created the media trend. For example, upon identification of the one or more media items 121, creator discovery component 318 can determine an identifier for a user and/or a client device 102 that provided the media item 121 and can transmit the notification to the client device 102 associated with the user. In some embodiments, the creator discovery component 318 can additionally or alternatively provide to the client device 102 one or more UI elements that enable the creator to control the user or distribution of their media item 121 in accordance with the media trend. For example, the one or more UI elements can enable the creator to prevent or limit notifying other users accessing the media item 121 that the media item 121 is associated with the media trend. In another example, the one or more UI elements can enable the creator to prevent or limit sharing of the media item 121 between other users of platform 120. In some embodiments, creator discovery component 318 can update media item data store 252 to indicate the preferences provided by the creator (e.g., based on user engagement with the one or more UI elements). Viewer discovery component 316 and/or media item manager 132 can provide access to the media item 121 and/or enable sharing of the media item 121 in accordance with the creator preferences, in some embodiments.

FIG. 4 is a block diagram of an example method 400 for real-time identification of media trends at a content sharing platform. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 400 can be performed by trend engine 152. For example, some or all of operations of method 400 can be performed by one or more components of trend identification module 210 (e.g., embedding generator 310, trend candidate generator 312, and/or trend candidate selector 314) and/or trend maintenance module 212.

It should be noted that although some examples and embodiments of the following sections are described with respect to embedding generator 310 and media trend detection, such examples and embodiments are provided for the purpose of explanation and illustration only. Such examples and embodiments can be performed by any component or module of trend engine 152, platform 120, system 100, and/or one or more other systems (not illustrated). Further, such examples and embodiments can be performed for any media characterization task, in accordance with embodiments described herein.

At block 402, processing logic receives a media item during a current time window for sharing with users of a platform. In some embodiments, a user (e.g., a creator) of platform 120 can provide (e.g., upload) the media item 121 via a client device 102. The user may upload the media item 121 during a current time period. At block 404, processing logic generates one or more embeddings representing features of the media item. Processing logic can generate the one or more embeddings upon (or soon after) receipt of the media item 121 from the client device 102 of the creator, in some embodiments. In other or similar embodiments, embedding generator 310 can obtain the one or more embeddings upon receiving an instruction from another module or component of platform 120 (e.g., trend maintenance module 212, trend exploration module 214, etc.). Such module or component of platform 120 may transmit the instruction to processing logic in accordance with embodiments described above and/or in accordance with a schedule of an emerging trend detection protocol (e.g., as defined by a developer or operator of platform 120).

FIG. 5 illustrates an example of generating an embedding for media trend detection of content sharing platforms, in accordance with implementations of the present disclosure. As described above, a media item 121 can include or be made up of a sequence of video frames 502 that each depict a still image of content associated with the media item 121. Each video frame, in some embodiments, can include a pixel array composed of pixel intensity data associated with visual features of the media item 121. When played in sequence with other frames 502 of the media item 121, the frames 502 depict motion on a playback surface (e.g., a UI of client device 102). In some embodiments, each video frame 502 may be associated with a segment of audio data 504. When played in sequence with frames 502, the audio data 504 provides an audio signal corresponding to the playback of the frames 502. As described herein, the sequence of video frames 502 may be generated by a camera component (e.g., a camera) of a client device 102 or another device of system 100.

Embedding generator 310 can obtain a set of video embeddings 506 based on one or more outputs of an image encoder 510. An image encoder refers to an AI model (or a component of an AI model) that transforms raw image data into a structured, high-dimensional representation (e.g., a feature vector) of features or information of the image. An image encoder 510 can take an image, such as a video frame 502, as an input and can extract features from the input image by applying a series of filters to capture various aspects of the image, such as edges, textures, colors, patterns, and so forth. The filters applied to the input image and/or the aspects of the image captured by the image encoder 510 may be defined and/or specified based on the training of the image encoder 510. In some embodiments, image encoder 510 is employed using a deep learning approach, such as that of a convolutional neural network (CNN) architecture. In such embodiments, the image encoder 510 can include or be made up of a network including multiple layers, such as a convolutional layer (e.g., which applies various filters to the image to create feature maps highlighting different features at various scales), an activation function layer (e.g., which introduces non-linearities into the network, allowing it to learn more complex patterns), a pooling layer (e.g., which reduces the dimensionality of the feature maps, which enable the representation to be abstract and invariant to small changes in the input image), and/or a normalization layer (e.g., which stabilize the learning process and improve the convergence of training of the image encoder 510). In some embodiments, an output of the image encoder 510 can include a feature vector (or a set of feature vectors) that represent the content of the input image in a compressed and informative way. In some embodiments, the image encoder 510 can include a vision transformer, a visual geometry group deep convolutional network (VGGNet) encoder, a residual network (ResNet) encoder, an inception encoder, an autoencoder, and so forth.

As indicated above, embedding generator 310 can provide one or more image frames 502 of media item 121 as an input to image encoder 510 and can obtain the set of video embeddings 506 based on one or more outputs of the image encoder 510. Each of the set of video embeddings 506 can include or correspond to a frame token, which refers to a unit of processed information output by an image encoder 510. Each frame token can represent the features of one or more frames 502 of the media item 121, in some embodiments. In some embodiments, embedding generator 310 can store the set of video embeddings 506 at memory 250, which can include or otherwise reference the frame tokens.

Embedding generator 310 can obtain a set of audio embeddings 508 based on one or more outputs of audio encoder 512. An audio encoder 512 refers to an AI model or engine that converts an audio signal into a vector representation that captures the audio features of the input audio data. In some embodiments, audio encoder can include an audio spectrogram transformer, which processes audio data by converting it to a spectrogram (e.g., a visual or numerical representation of an audio signal's frequency spectrum over time) and uses a transformer architecture to extract meaningful features from the audio, such as the audio features described herein. Embedding generator 310 can provide audio data 504 of media item 121 as an input to audio encoder 512 and can obtain the set of audio embeddings 508 based on one or more outputs of the audio encoder 512. Each of the set of audio embeddings 508 can correspond to a segment of audio for a frame 502. In some embodiments, embedding generator 310 can store the set of audio embeddings 508 at memory 250.

In some embodiments, embedding generator 310 can provide the set of video embeddings 506 and the set of audio embeddings 508 as an input to a concatenation engine 514. Concatenation engine 514 can perform one or more concatenation operations to concatenate each frame token of the set of video embeddings 506 with a corresponding audio embedding of the set of audio embeddings 508. Based on the concatenation operations, embedding generator can generate the set of audiovisual embeddings 516. As illustrated by FIG. 5, the set of audiovisual embeddings 516 includes each frame token of the set of video embeddings 506 concatenated with each corresponding audio embedding of the set of audio embeddings 508.

In some embodiments, embedding generator 310 can additionally or alternatively perform one or more attention pooling operations to the concatenated video and audio embeddings. An attention pooling operation refers to an operation that reduces the dimensionality of a feature map, which enables the output representation to be abstract and invariant to small changes. In some embodiments, the attention pooling operations can include a generative pooling operation and/or a contrastive pooling operation. In some embodiments, embedding generator 310 can provide the concatenated video and audio embeddings as an input to the one or more attention pooling operations and can obtain the set of audiovisual embeddings 516 based on one or more outputs of the attention pooling operation(s).

In some embodiments, embedding generator 310 can obtain a set of textual embeddings 518 based on one or more outputs of a text encoder 520. A text encoder refers to an AI model (or a component of an AI model) that transforms raw text into a fixed, high-dimensional representation (e.g., a feature vector) of semantic properties of the input text. A text encoder 520 can take text as an input and can break down the input text into smaller components, such as words, subwords, or characters (e.g., tokens). Text encoder 520 can then map each token to a vector in a high-dimensional space, which are learned to capture semantic and syntactic meanings of the words (e.g., according to a training of the text encoder 520). Text encoder 520 can update or adjust the token embeddings based on the context in which they appear in the text and can combine the contextual embeddings of the individual tokens into a single or sequence of vectors that represent larger units of text (e.g., sentences, paragraphs, entire documents, etc.). In some embodiments, text encoder 520 can be or otherwise include a recurrent neural network (RNN), a convolutional neural network (CNN), a transformer, a pre-trained language model (e.g., a Bidirectional Encoder Representations from Transformers (BERT) model, a Generative Pre-trained Transformer (GPT) model, etc.), and so forth.

In some embodiments, embedding generator 310 can provide textual data 522 associated with the media item 121 as an input to text encoder 520 and can obtain the set of textual embeddings 518 as an output of the text encoder 520. The textual data 522 can include information pertaining to the content of the media item 121. For example, textual data 522 can include a title of the media item 121, a caption of the media item 121 (e.g., as provided by a creator of the media item 121), one or more tags or keywords associated with the media item 121 (e.g., as provided by the creator or another system or process associated with platform 120), and so forth. In other or similar embodiments, textual data 522 can include or otherwise reference a transcript of an audio of the media item 121, comments provided by one or more users (e.g., viewers) of the media item 121, search queries associated with media item 121, and so forth.

Each of the set of textual embeddings 518 obtained based on output(s) of the text encoder 520 can include or correspond to a text token, which refers to a unit of processed information output by a text encoder 520. Each text token can represent features of one or more segments of text (e.g., a word, a subword, a character, a sentence, a paragraph, etc.) of textual data 522. In some embodiments, the set of textual embeddings 518 can include a single text token that represents the entirety of the textual data 522. In other or similar embodiments, the set of textual embeddings 518 can include multiple text tokens that each represent a distinct segment of textual data 522.

As illustrated by FIG. 5, embedding generator 310 can generate fused textual-audiovisual data 524 based on the set of audiovisual embeddings 516 and the set of textual embeddings 518. In some embodiments, fusion engine 526 can perform one or more concatenation operations to concatenate the set of textual embeddings 518 to each respective frame token and audio embedding of the set of audiovisual embeddings 516 to generate a set of concatenated textual and audiovisual embeddings. In additional or alternative embodiments, fusion engine 526 generate a set of frame tokens based on the set of concatenated textual and audiovisual embeddings, where each respective frame token represents a correspondence between a respective video embedding, a respective audio embedding, and the set of textual embeddings. In some embodiments, fusion engine 526 can include or otherwise implement a transformer encoder. A transformer encoder is an AI model (or is a component of an AI model) that transforms input data into a continuous representation (e.g., feature vector) that retains semantic meaning and relational information between different parts of the input. In some embodiments, a transformer encoder can include a stack of identical layers that each contain a multi-head self-attention mechanism and a position-wise feed-forward network. The multi-head self-attention mechanism of each layer allows the model to weigh the importance of different input elements (e.g., video tokens, audio embeddings, text tokens, etc.), irrespective of their positions in the input sequence. Such mechanism also splits the self-attention process into multiple “heads,” allowing the model to jointly attend to information from different representation subspaces at different positions. Fusion module 526 can provide the set of concatenated textual and audiovisual embeddings as an input to the transformer encoder and can obtain a set of frame tokens as an output of the transformer encoder. The fused textual-audiovisual data 524 can include the obtained set of frame tokens.

In some embodiments, fusion module 526 can generate a feature pyramid 528 based on the set of frame tokens. A feature pyramid 528 refers to a collection of data that is generated based on audiovisual embeddings and is a multi-scale representation of content associated with the audiovisual features of the audiovisual embeddings. A feature pyramid 528 has a hierarchical structure where each level of the pyramid represents features at a different scale, with higher levels having coarser (e.g., lower resolution but semantically stronger) features and lower levels having finer (e.g., higher resolution but semantically weaker) features. In some embodiments, the highest level of the feature pyramid 528 includes embeddings associated with an entire image (e.g., of an image frame 502) and/or large portions of the image, which provides the high-level semantic information pertaining to content of the image (e.g., the presence of an object). As indicated above, embeddings of the highest level have the lowest resolution but cover the largest field of view of the content. Intermediate levels of the feature pyramid 528 progressively increase in resolution and decrease in field of view. The lowest level of the feature pyramid 528 includes embeddings with the highest resolution, and depict small regions of the image to capture fine details of the overall image. In some embodiments, the feature pyramid 528 can include or correspond to a Feature Pyramid Network (FPN), which includes connections between features from different scales.

Fusion module 526 can generate the feature pyramid by performing one or more sampling operations with respect to the frame tokens output by the transformer encoder. The one or more sampling operations can include down sampling operations, which reduce the resolution of input frame tokens and/or upsampling operations, which increase the resolution of input frame tokens. In some embodiments, a down sampling operation can include or involve pooling or strided convolutions in a convolutional neural network to reduce dimensionality of the features associated with an input frame token. In additional or alternative embodiments, an upsampling operation can involve bilinear interpolation, transposed convolutions, and/or learnable upsampling to recover spatial resolution of the input frame token.

In an illustrative example, the highest level of the feature pyramid 528 can include the frame tokens output by the transformer encoder. Fusion module 526 can perform one or more down sampling operations with respect to the frame tokens to generate one or more intermediate layers of the feature pyramid 420. To generate each lower level of the feature pyramid 528, fusion module 526 may perform a down sampling operation with respect to the frame token of the level directly above the lower level. Each token of the feature pyramid 528 (including the tokens of the highest level) are referred to herein as sampled tokens.

Referring back to FIG. 4, at block 406, processing logic determines, based on the one or more embeddings, whether a degree of similarity between the features of the media item and the features of one or more additional media items of the platform identified during the current time window satisfies one or more similarity criteria. The additional media item(s) 121 may be provided by another user of platform 120 during the current time period. For purposes of explanation and illustration only, the media item obtained with respect to block 412 is referred to as a media item 121A and an additional media item(s) received from another user of platform 120 is referred to as additional media item 121B. It should be noted that although some embodiments and examples are described with respect to comparing the features of media item 121A to additional media item 121B, such embodiments and examples can be applied to situations where media item 121A is applied to any and/or all media items 121 received during the current time period.

In some embodiments, processing logic can obtain embeddings associated with the additional media item 121B, as described above. The embeddings can include audiovisual embeddings 516, textual embeddings 518, and/or the feature pyramid 528, described above. Processing logic can provide the embeddings generated for media item 121A and media item 121B as an input to trend detection model 184 and can obtain one or more outputs of trend detection model 184. The one or more outputs can indicate a distance between the visual and audio features of the media item 121A and the media item 121B, in view of the textual features associated with such media items 121. The distance represented by the output(s) of the trend detection model 184 can represent a degree of similarity between the media item 121A and the media item 121B. Processing logic can determine whether the similarity criteria are satisfied by determining whether the distance between the features of media item 121A and media item 121B falls below a threshold distance and/or the degree of similarity between the media item 121A and the media item 121B exceed a threshold degree of similarity.

Responsive to a determination that the similarity criteria are not satisfied, method 400 returns to block 402. At block 402, processing logic can continue to receive media items 121 provided by users of platform 120 during the current time period. As new media items 121 are received by users of the platform 120, processing logic can compare the embeddings generated for such new media items 121 with embeddings for other media items 121 received during the current time period. In an illustrative example, upon a determination that the similarity criteria are not satisfied with respect to media item 121A and media item 121B, the embeddings generated for such media items can be stored at memory 250, in some embodiments. Upon receipt of a media item 121c during the current time period, processing logic can generate embedding(s) for the media item 121c, as described above, and can determine a degree of similarity between the embeddings for media item 121A, media item 121B, and media item 121c, as described herein.

Responsive to a determination that the similarity criteria are satisfied with respect to media item 121A and media item 121B, method 400 proceeds to block 408. At block 408, processing logic determines whether the media item and the one or more additional media items correspond to an emerging media trend of the platform. In some embodiments, trend identification module 210 can determine whether the media item 121A and media item 121B correspond to an emerging media trend based on engagement data associated with the media items. Engagement data refers to measurable interactions that users have with content. Engagement data can include view-based metrics, interaction metrics, click-based metrics, sentiment and feedback, audience engagement patterns, and so forth. View-based metrics can include, for example, impressions (e.g., a number of times a media item was accessed or required by users), access duration (e.g., how long users spent watching the media item), completion rate (e.g., a number or percentage of users that accessed the entire content item), and so forth. Interaction metrics can include positive reactions for a media item (e.g., “likes”), negative reactions for a media item (e.g., “dislikes”), comments, a number of times users have shared the media item with other users, a number of times users have saved the media item for later access, and so forth. Click-based metrics can include, for example, a click-through-rate (CTR) associated with a media item (e.g., a number or percentage of users who clicked on or otherwise engaged with the media item out of those who accessed the media item), link clicks (e.g., a number of times users clicked embedded or related links), call-to-action engagement rates (e.g., a number of times users have performed or otherwise engaged with prompts associated with the media item, such as “learn more”) and so forth. Sentiment and feedback can include, for example, a tone of user comments (e.g., positive, negative, neutral), a flag or other indication that a media item 121, or content of the media item 121, is reported to be inappropriate or misleading, and so forth. Audience engagement patterns can include, for example, a number of repeat views by the same user, an engagement time distribution (e.g., a time during the day or the week when engagement typically occurs), and so forth.

Platform 120 can collect engagement data for media items 121 upon receipt of the media items 121 and/or as users engage with the media items. As described above, platform 120 can provide a client device 102 with a UI that enables users to access media items 121 of platform 120. The UI can include one or more listening components. These listening components can detect user actions with respect to a media item 121, such as clicking a “play,” “pause,” or “share” button, liking or commenting on a post, and so forth. Platform 120 can collect the engagement data based on signals received from the listening components. In some embodiments, the listening component(s) can be embedded in a web application of platform 120 and/or a mobile application of platform 120. The listening components can collect and share information regarding user engagement with a media item via tools, libraries, code samples, documentation, APIs, etc. associated with the web application and/or the mobile application. In some embodiments, platform 120 can collect engagement data for media items 121 and provide the engagement data to anomaly engine 162 in real time (or approximately real time), which can cause anomaly engine 162 to update the time series data without delay.

In some embodiments, upon collecting the engagement data for media item 121A and/or media item 121B, processing logic can provide the engagement data to the anomaly engine 162. Processing logic can additionally or alternatively provide embeddings generated for media item 121A and/or media item 121B as another input to anomaly engine 162. Anomaly engine 162 can include or otherwise correspond to a real-time forecasting system that monitors, analyzes, and predicts relationships between content properties in real-time. Anomaly engine 162 can generate time series data that reflects a fluctuation of user engagement with respect to media items 121 changes over a specific period. For example, it can reveal trends or fluctuations in engagement for media items that share similar characteristics. By analyzing this time series data, the anomaly engine 162 can detect periods when user engagement with certain types of media items is unexpectedly high or low, which may indicate the emergence of a new media trend at platform 120.

As described above, processing logic can provide engagement data and embeddings for media items 121A and 121B to anomaly engine 162. The anomaly engine 162 uses this information to create or update time series data for media items 121 received during the current time window. This time series data can map engagement metrics (e.g., view-based metrics, click-based metrics, etc.), as indicated by the engagement data and features of each media item 121 (e.g., audiovisual or textual characteristics) received during the current time window as indicated by the embeddings. Using the updated time series data, anomaly engine 162 can calculate aggregated engagement metrics that show overall user engagement trends for groups of media items with similar features. For example, an aggregated engagement metric might represent the total number of views for all media items that share certain audiovisual or textual features, as identified by their embeddings. Processing logic can then retrieve these aggregated engagement metrics from anomaly engine 162.

In some embodiments, processing logic can determine whether media item 121A and media item 121B correspond to an emerging trend by comparing their aggregated engagement metrics to one or more engagement criteria. The aggregated engagement metric(s) can satisfy the engagement criteria if the engagement metrics exceed a certain threshold or are higher than those for other groups of media items with different features. If the aggregated engagement metrics for media items 121A and 121B meet or surpass these criteria, processing logic determines that these items are part of an emerging media trend. Upon determining that the aggregated engagement metric(s) associated with media item 121A and media item 121B satisfy the engagement criteria, processing logic can determine that media item 121A and media item 121B correspond to the emerging media trend.

Responsive to a determination that the emerging trend is not detected (e.g., the media item and the additional media item(s) do not correspond to an emerging media trend), method 400 returns to block 402. As described above, upon determining that the emerging trend is not detected, processing logic can continue to receive new media items 121 during the current time period and can determine a degree of similarity between the new media items 121 and other media items 121 received during the current time period. Upon determining that the degree of similarity between the new media items 121 and the other media items 121 satisfies the similarity criteria, processing logic can determine, based on the engagement data for such media items 121 provided to anomaly engine 162, whether the emerging trend is detected.

Responsive to a determination that the emerging trend is detected (e.g., the media item and the additional media item(s) correspond to an emerging media trend), method 400 proceeds to block 410. At block 410, processing logic provides, during the current time window, an indication of the emerging media trend for presentation to the users of the platform. In some embodiments, another user may provide a request for access to content during the current time window. Media item manager 132 may identify media item 121A or media item 121B for presentation to the user in response to the request (e.g., in accordance with a media item selection protocol or algorithm of platform 120). Processing logic provides the media item to the client device in accordance with the request and an indication of whether the media item is associated with the one or more media trends for presentation to a user of the client device. Viewer discovery component 316 can provide the notification of whether the media item 121 is associated with the media trend for presentation to the user with the media item 121. In some embodiments, viewer discovery component 316 can additionally or alternatively provide one or more UI elements to client device 102 that enables the user to access other media items 121 associated with the media trend, as described above.

At block 412, processing logic, optionally, designates the media item (or an additional media item) as a template corresponding to the emerging media trend. In some embodiments, processing logic can determine whether the media item 121A or media item 121B, which are determined to correspond to the emerging media trend, satisfy one or more template criteria. Media item 121A and/or media item 121B may satisfy the template criteria if a number of common features of media item 121A and/or media item 121B, and other media items 121 identified to correspond to the media trend, is larger than the number of common features of the other media items, in some embodiments. In other or similar embodiments, media item 121A and/or media item 121B may satisfy the template criteria if one or more engagement metrics, of the engagement data collected above, for the media item 121A and/or media item 121B is larger than engagement metrics for other media items 121 identified to correspond to the media trend. Upon determining that media item 121A and/or media item 121B satisfy the one or more template criteria, processing logic can designate the media item 121A and/or media item 121B as a media trend template, which can be used to identify other media items 121 corresponding to the media trend, as described herein. In some embodiments, processing logic can update trend template data 256 to include the embeddings and/or the feature pyramid of the media item 121A and/or media item 121B.

At block 414, processing logic, optionally, identifies additional media items received during a future time window as corresponding to the emerging media trend based on the embedding(s) generated for the media item. As described herein, platform 120 can continue to receive new media items 121 for sharing with users of platform 120 during a future time window. Processing logic can obtain embeddings representing the features of such new media items 121 and compare such embeddings with the embeddings of trend template data 256 (e.g., embeddings generated for media item 121A and/or media item 121B) to determine whether the new media items 121 correspond to the emerging media trend, as described herein.

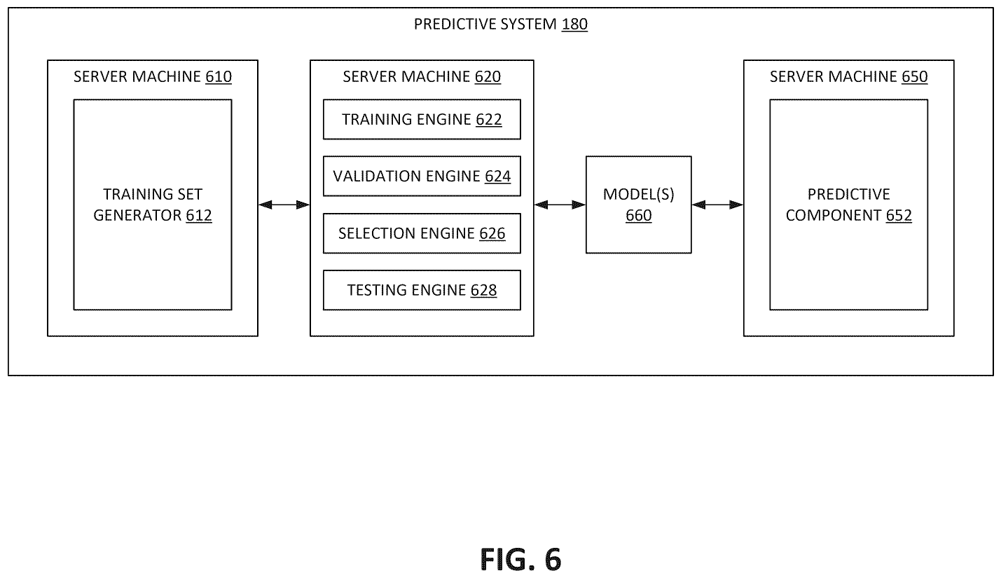

FIG. 6 is a block diagram of an illustrative predictive system, in accordance with implementations of the present disclosure. As illustrated in FIG. 6, predictive system 180 can include a training set generator 612 (e.g., residing at server machine 610), a training engine 612, a validation engine 624, a selection 626, and/or a testing engine 628 (e.g., each residing at server machine 620), and/or a predictive component 652 (e.g., residing at server machine 650). Training set generator 612 may be capable of generating training data (e.g., a set of training inputs and a set of target outputs) to train one or more AI model 660. In some embodiments, AI model 660 can include image encoder 510, audio encoder 512, and/or text encoder 520.

Training set generator 612 can generate a training dataset to train the image encoder 510 by obtaining a set of training videos and a set of feature data indicating visual features of the training videos. The visual features indicated by the set of feature data can include visual features for media items 121, as described herein. The set of training videos can be obtained from a publicly accessible data store or a privately accessible data store. In some embodiments, the set of feature data can be stored with the training videos. In such embodiments, training set generator 612 can obtain the set of feature data from the data store that stores the set of training videos. In other or similar embodiments, training set generator 612 can generate the set of feature data for the set of training videos. For example, training set generator 612 can provide a respective training video as an input to one or more other machine learning models trained to extract particular features of a given input video. Training set generator 612 can obtain the features for the training video based on one or more outputs of the other machine learning models and can include such features in the set of feature data. In yet other or similar embodiments, the set of training videos and the set of feature data can be provided to training set generator 612 by a developer or operator of platform 120.

In some embodiments, training set generator 612 can generate an input-output mapping based on the obtained set of training videos and the obtained set of feature data. An input of the input-output mapping can include a respective training video of the set of training videos and the output of the input-output mapping can include feature data pertaining to the respective training video. In some embodiments, an input-output mapping can be generated for a respective training video, or a segment (e.g., a video frame) of the respective training video. Training set generator 612 can update a training dataset to include the generated input-output mapping, in some embodiments.

Training set generator 612 can generate a training dataset to train the audio encoder 512 by obtaining a set of training audio signals and a set of feature data indicating audio features of the training audio signals. The audio features indicated by the set of feature data can include audio features for media items 121, as described herein. The set of training audio signals can be obtained from a publicly accessible data store or a privately accessible data store. In some embodiments, the set of training audio signals can include audio signals associated with videos of the set of training videos, as described above. In some embodiments, the set of feature data can be stored with the training audio signals and/or training videos. In such embodiments, training set generator 612 can obtain the set of feature data from the data store that stores the set of training audio signals and/or training videos. In other or similar embodiments, training set generator 612 can generate the set of feature data for the set of training audio signals. For example, training set generator 612 can provide a respective training audio signals as an input to one or more other machine learning models trained to extract particular features of a given input audio signals. Training set generator 612 can obtain the features for the training audio signals based on one or more outputs of the other machine learning models and can include such features in the set of feature data. In yet other or similar embodiments, the set of training audio signals and the set of feature data can be provided to training set generator 612 by a developer or operator of platform 120.

In some embodiments, training set generator 612 can generate an input-output mapping based on the obtained set of training audio signals and the obtained set of feature data. An input of the input-output mapping can include a respective training audio signal of the set of training audio signals and the output of the input-output mapping can include feature data pertaining to the respective training audio signal. In some embodiments, an input-output mapping can be generated for a respective training audio signal, or a segment (e.g., audio sequence) of the respective training audio signal. Training set generator 612 can update a training dataset to include the generated input-output mapping, in some embodiments. In some embodiments, the training dataset for training the image encoder 510 can be the same or different from the training dataset for training the audio encoder 512.

Training set generator 612 can generate a training dataset for training text encoder 520 by obtaining a set of textual data for one or more media items (e.g., video items, audio items, etc.) and a set of textual features for the obtained set. Training set generator 612 can obtain the set of textual data and the set of textual features in accordance with embodiments described above. In some embodiments, the set of textual data and the set of textual features can be associated with the training videos and/or training audio signals described above. In other or similar embodiments, the set of textual data and the set of textual features can be associated with other media items.

In some embodiments, training set generator 612 can generate an input-output mapping based on the obtained set of textual data and the obtained set of textual features. An input of the input-output mapping can include a respective textual data for a media item and the output of the input-output mapping can include one or more textual features pertaining to the respective textual data. Training set generator 612 can update a training dataset to include the generated input-output mapping, in some embodiments. In some embodiments, the training dataset for training the text encoder 520 image encoder 510 can be the same or different from the training dataset for training the video encoder 510 and/or the audio encoder 512.

Training engine 622 can train an AI model 660 using the training data from training set generator 612. The AI model 660 can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the AI model 660 that captures these patterns. The AI model 660 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

Validation engine 624 may be capable of validating a trained machine learning model 182 using a corresponding set of features of a validation set from training set generator 612. The validation engine 624 may determine an accuracy of each of the trained machine AI 660 based on the corresponding sets of features of the validation set. The validation engine 624 may discard a trained AI model 660 that has an accuracy that does not meet a threshold accuracy. In some embodiments, the selection engine 626 may be capable of selecting a trained machine learning model 182 that has an accuracy that meets a threshold accuracy. In some embodiments, the selection engine 626 may be capable of selecting the trained AI model 660 that has the highest accuracy of the trained AI models 660.

The testing engine 686 may be capable of testing a trained AI model 660 using a corresponding set of features of a testing set from training set generator 612. For example, a first trained machine learning model 182 that was trained using a first set of features of the training set may be tested using the first set of features of the testing set. The testing engine 628 may determine a trained machine learning model 182 that has the highest accuracy of all of the trained machine learning models based on the testing sets.

As described above, predictive component 652 of server 650 may be configured to feed data as input to model 182 and obtain one or more outputs. In some embodiments, predictive component 652 can include or be associated with trend candidate generator 312 and/or trend maintenance model 212. In such embodiments, predictive component 652 can feed video frames 502, audio data 504, and/or textual data 522 for a media item 121 as an input to model 182, in accordance with previously described embodiments.

In Isome embodiments, image encoder 510 and/or audio encoder 512 can be based on a pretrained image-text model (e.g., a contrastive captioner (CoCa) model) that is trained to perform video-text tasks. Predictive system 180 can obtain such pretrained model from a publicly accessible database and/or a private database. In such embodiments, predictive system 180 can train image encoder 510 and/or audio encoder 512 by performing one or more finetuning operations using the training dataset, as described above.

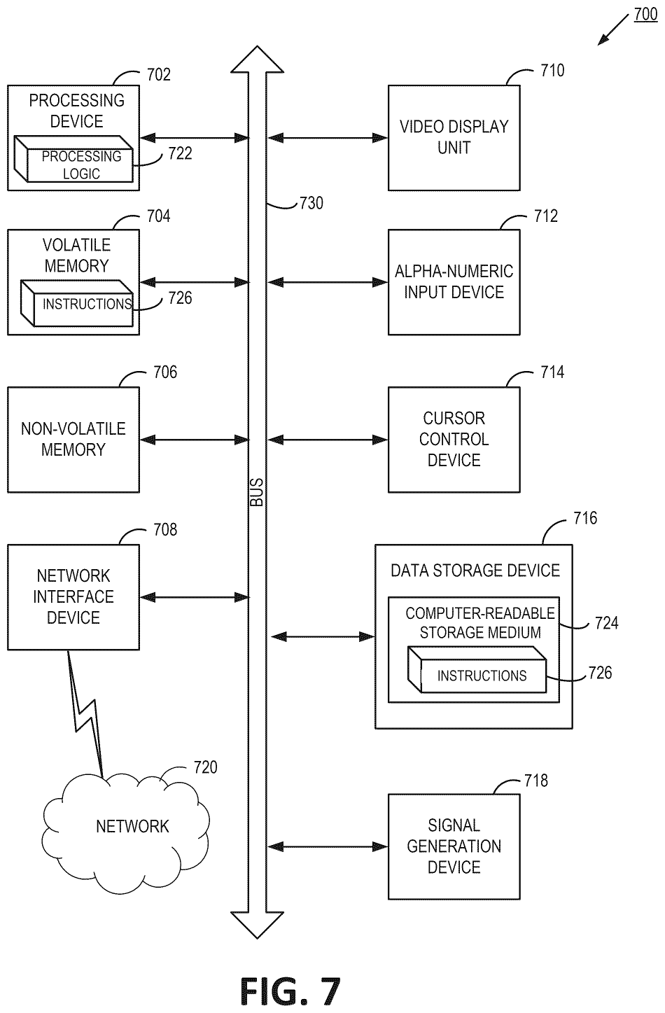

FIG. 7 is a block diagram illustrating an exemplary computer system 700, in accordance with implementations of the present disclosure. The computer system 700 can correspond to platform 120 and/or client devices 102A-N, described with respect to FIG. 1. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which one or more sets of instructions are stored 705 embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the data collected is anonymized prior to performing any analysis to obtain any statistical patterns so that the identity of the user cannot be determined from the collected data.

What is claimed is:

1. A method to identify an emerging media trend of a platform, the method comprising:
generating one or more embeddings representing features of a media item of the platform identified during a current time window;
determining, based on the one or more embeddings, whether a degree of similarity between the features of the media item and features of one or more additional media items of the platform identified during the current time window satisfies one or more similarity criteria;
responsive to determining that the degree of similarity satisfies the one or more similarity criteria, determining that the media item and the one or more additional media items correspond to the emerging media trend of the platform; and
providing, during the current time window, an indication of the emerging media trend for presentation to a user of the platform via a client device.

2. The method of claim 1, wherein determining that the media item and the one or more additional media items correspond to an emerging media trend of the platform comprises:
obtaining engagement data associated with the media item and the one or more additional media items, the engagement data representing user engagement with respect to the media item and the one or more additional media items during at least one of the current time window or a prior time window; and
determining that the obtained engagement data satisfies one or more engagement criteria.

3. The method of claim 2, further comprising:
obtaining a set of additional embeddings representing the features of the one or more additional media items;
providing the one or more embeddings representing the features of the media item, the set of additional embeddings representing the features of the one or more additional media items, and the obtained engagement data as an input to an anomaly engine, wherein the anomaly engine detects a fluctuation of user engagement with content of the platform that; and
obtaining one or more outputs of the anomaly engine, the one or more outputs indicating one or more aggregated engagement metrics each representing a trend of user engagement with respect content having features matching at least one of the features of the media item or the features of the one or more additional media items,
wherein determining that the obtained engagement data satisfies the one or more engagement criteria comprises determining that a value of the one or more aggregated engagement metrics exceeds a threshold value.

4. The method of claim 1, further comprising:
determining that the media item or an additional media item of the one or more additional media items satisfy one or more template criteria; and
determining whether an additional degree of similarity between the features of the media item or the additional media item and features of one or more media items identified during a future time window satisfies the one or more similarity criteria; and
responsive to determining that the additional degree of similarity satisfies the one or more similarity criteria, determining that the one or more media items identified during the future time window also correspond to the emerging media trend.

5. The method of claim 4, wherein determining that the media item or the additional media item satisfies the one or more template criteria comprises:
determining that a number of common features of the media item or the additional media item and other media items corresponding to the media trend is larger than the number of common features of the other media items; and
determining that a value of one or more engagement metrics representing user engagement with the media item or the additional media item is larger than a value of the one or more engagement metrics for the other media items.

6. The method of claim 1, wherein the one or more embeddings representing the features of the media item comprise at least one of an audiovisual embedding that represents audiovisual features of the media item or a textual embedding that represents a textual feature of the media item.

7. The method of claim 6, wherein:
the audiovisual features of the media item comprise at least one of:
a scene depicted by a sequence of video frames of the media item,
an object of the scene depicted by the sequence of video frames,
at least one of an action, a motion, or a pose of the object of the scene,
one or more colors included in the scene,
one or more lighting features associated with the scene,
a pitch of an audio signal of the media item,
a timbre of the audio signal,
a rhythm of the audio signal,
speech content of the audio signal,
speaker characteristics associated with the audio signal,
environmental sounds associated with a scene of the media item,
spectral features of the audio signal, or
temporal dynamics of the audio signal, and
the textual features of the media item comprise at least one of:
a title associated with the media item,
a description associated with the media item,
a keyword associated with the media item, or
a transcript associated with the media item.

8. The method of claim 6, wherein generating the one or more embeddings comprises:
obtaining a video embedding representing visual features of a sequence of video frames of the media item;
obtaining an audio embedding representing audio features of the sequence of video frames;
obtaining a textual embedding representing textual features associated with content of the sequence of video frames;
performing one or more concatenation operations to concatenate the video embedding and the audio embedding with the textual embedding; and
responsive to obtaining an output of the one or more concatenation operations, performing one or more attention pooling operations to the obtained output, wherein an output of the one or more attention pooling operations comprises the one or more embeddings.

9. The method of claim 1, wherein providing the indication of the emerging media trend for presentation to the user comprises:
updating a user interface (UI) of the client device to include one or more UI elements indicating that at least one of the media item or the one or more additional media items are associated with the media trend.

10. The method of claim 9, further comprising:
responsive to detecting a user interaction with at least one of the UI elements, providing the user with access to content of one or more of the at least one of the media item or the one or more additional media items, or one or more other media items corresponding to the emerging media trend.

11. A system comprising:
a memory; and
a processor coupled to the memory, the processor to perform operations associated with identifying an emerging media trend of a platform, the operations comprising:
generating one or more embeddings representing features of a media item of the platform identified during a current time window;
determining, based on the one or more embeddings, whether a degree of similarity between the features of the media item and features of one or more additional media items of the platform identified during the current time window satisfies one or more similarity criteria;
responsive to determining that the degree of similarity satisfies the one or more similarity criteria, determining that the media item and the one or more additional media items correspond to the emerging media trend of the platform; and
providing, during the current time window, an indication of the emerging media trend for presentation to a user of the platform via a client device.

12. The system of claim 11, wherein the operations further comprise:
obtaining engagement data associated with the media item and the one or more additional media items, the engagement data representing user engagement with respect to the media item and the one or more additional media items during at least one of the current time window or a prior time window; and
determining that the obtained engagement data satisfies one or more engagement criteria.

13. The system of claim 12, wherein the operations further comprise:
obtaining a set of additional embeddings representing the features of the one or more additional media items;
providing the one or more embeddings representing the features of the media item, the set of additional embeddings representing the features of the one or more additional media items, and the obtained engagement data as an input to an anomaly engine, wherein the anomaly engine detects a fluctuation of user engagement with content of the platform; and
obtaining one or more outputs of the anomaly engine, the one or more outputs indicating one or more aggregated engagement metrics each representing a trend of user engagement with respect to content having features matching at least one of the features of the media item or the features of the one or more additional media items,
wherein determining that the obtained engagement data satisfies the one or more engagement criteria comprises determining that a value of the one or more aggregated engagement metrics exceeds a threshold value.

14. The system of claim 11, wherein the operations further comprise:
determining that the media item or an additional media item of the one or more additional media items satisfy one or more template criteria; and
determining whether an additional degree of similarity between the features of the media item or the additional media item and features of one or more media items identified during a future time window satisfies the one or more similarity criteria; and
responsive to determining that the additional degree of similarity satisfies the one or more similarity criteria, determining that the one or more media items identified during the future time window also correspond to the emerging media trend.

15. The system of claim 14, wherein the operations further comprise:
determining that a number of common features of the media item or the additional media item and other media items corresponding to the media trend is larger than the number of common features of the other media items; and
determining that a value of one or more engagement metrics representing user engagement with the media item or the additional media item is larger than a value of the one or more engagement metrics for the other media items.

16. A non-transitory computer-readable medium comprising instructions that, when executed by a processor, cause the processor to perform operations associated with identifying an emerging media trend of a platform, the operations comprising:
generating one or more embeddings representing features of a media item of the platform identified during a current time window;
determining, based on the one or more embeddings, whether a degree of similarity between the features of the media item and features of one or more additional media items of the platform identified during the current time window satisfies one or more similarity criteria;
responsive to determining that the degree of similarity satisfies the one or more similarity criteria, determining that the media item and the one or more additional media items correspond to the emerging media trend of the platform; and
providing, during the current time window, an indication of the emerging media trend for presentation to a user of the platform via a client device.

17. The non-transitory computer-readable medium of claim 16, wherein operations further comprise:
obtaining engagement data associated with the media item and the one or more additional media items, the engagement data representing user engagement with respect to the media item and the one or more additional media items during at least one of the current time window or a prior time window; and
determining that the obtained engagement data satisfies one or more engagement criteria.

18. The non-transitory computer-readable medium of claim 17, wherein the operations further comprise:
obtaining a set of additional embeddings representing the features of the one or more additional media items;
provide the one or more embeddings representing the features of the media item, the set of additional embeddings representing the features of the one or more additional media items, and the obtained engagement data as an input to an anomaly engine, wherein the anomaly engine detects a fluctuation of user engagement with content of the platform; and
obtain one or more outputs of the anomaly engine, the one or more outputs indicating one or more aggregated engagement metrics each representing a trend of user engagement with respect to content having features matching at least one of the features of the media item or the features of the one or more additional media items,
wherein determining that the obtained engagement data satisfies the one or more engagement criteria comprises determining that a value of the one or more aggregated engagement metrics exceeds a threshold value.

19. The non-transitory computer-readable medium of claim 16, wherein the instructions, when executed by the processor, further cause the processor to:
determining that the media item or an additional media item of the one or more additional media items satisfy one or more template criteria; and
determining whether an additional degree of similarity between the features of the media item or the additional media item and features of one or more media items identified during a future time window satisfies the one or more similarity criteria; and
responsive to determining that the additional degree of similarity satisfies the one or more similarity criteria, determining that the one or more media items identified during the future time window also correspond to the emerging media trend.

20. The non-transitory computer-readable medium of claim 19, wherein the instructions, when executed by the processor, further cause the processor to:
determining that a number of common features of the media item or the additional media item and other media items corresponding to the media trend is larger than the number of common features of the other media items; and
determining that a value of one or more engagement metrics representing user engagement with the media item or the additional media item is larger than a value of the one or more engagement metrics for the other media items.
